(19) United States
(12) Patent Application Publication
(10) Pub. No.: US 2015/0226971 A1
(43) Pub. Date: Aug. 13, 2015

(54) HEAD-MOUNT TYPE DISPLAY APPARATUS

(71) Applicant: SAMSUNG ELECTRONICS CO., LTD., Suwon-si (KR)

(72) Inventors: Sung-tae KIM, Seoul (KR); Yong-Dok CHA, Yongin-si (KR)

(73) Assignee: SAMSUNG ELECTRONICS CO., LTD., Suwon-si (KR)

(21) Appl. No.: 14/620,844

(22) Filed: Feb. 12, 2015

(30) Foreign Application Priority Data
Feb. 13, 2014 (KR) 10-2014-0016524

(51) Int. Cl. G02B 27/01

(52) U.S. Cl. CPC G02B 27/0172; G02B 27/0176; G02B 2027/0178

(57) ABSTRACT

A head-mount type display apparatus includes: a display configured to display an image; a light guide plate configured to transmit light which enters the light guide plate through a light incident surface formed at a first side of the light guide plate; a plurality of first split mirrors configured to be arranged in sequence along a first direction, and reflect light so that light from the display can be split in the first direction and enter the light incident surface; and a plurality of second split mirrors configured to be arranged in sequence along a second direction, split light transmitted through the light guide plate in the second direction, and reflect the split light so that the image displayed on the display can be recognized.

### CROSS-REFERENCE TO RELATED APPLICATION

This application claims priority from Korean Patent Application No. 10-2014-0016524, filed on Feb. 13, 2014 in the Korean Intellectual Property Office, the disclosure of which is incorporated herein by reference in its entirety.

### BACKGROUND

1. Field

Apparatuses and methods consistent with the exemplary embodiments relate to a head-mount type display apparatus capable of displaying images at positions adjacent to a human's eyes while being mounted on a human's head, and more particularly to a head-mount type display apparatus which has a lightweight and thin structure optical system for displaying an image.

2. Description of the Related Art

A display apparatus has a display panel for displaying an image and displays an image signal or image data of various types of formats, which is received externally, as an image on the panel. In general, the display apparatus includes a television (TV), a monitor, etc. A display panel can be a liquid crystal display panel, a plasma display panel, etc. and can be used with various types of display apparatuses. Recently, a large screen panel greater than 40 inches has been used as a display apparatus and is available to general users.

With developments in technology, various types of display apparatuses have been proposed. For example, there is a head-mount type display apparatus. A head-mount type display apparatus can be in the form of eyeglasses which can be mounted on a human's head. A head-mount type display apparatus has a structure which includes glass for covering a user's two eyes or can include glass to cover only one eye and is supported by a frame which is mounted to a user's ear or head. Inside the frame, a processing module for processing an image signal, a battery, etc. are placed.

The head-mount type display apparatus transmits an image to a user's eye through the glasses which cover his/her eyes while displaying the image, so that the user can recognize the image. Therefore, a user can recognize the image as if it is displayed on a large screen even though the head-mount type display apparatus itself is relatively small.

However, since the head-mount type display apparatus is mounted on a user's head, there is a need to minimize the size and weight of the apparatus in order to relieve user fatigue do to, for example, the size and weight of the head-mount type display apparatus.

### SUMMARY

In accordance with an aspect of an exemplary embodiment, there is provided a head-mount type display apparatus including: a display configured to display an image; a light guide plate configured to transmit light which enters the light guide plate through a light incident surface formed at a first side of the light guide plate; a plurality of first split mirrors configured to be arranged in sequence along a first direction, and reflect light so that light from the display can be split in the first direction and enter the light incident surface; and a plurality of second split mirrors configured to be arranged in sequence along a second direction which is preset differently from the first direction, split light transmitted through the light guide plate in the second direction, and reflect the split light so that the image displayed on the display can be recognized, wherein the light incident surface of the light guide plate including an inclined surface formed at a preset angle to an axial line of the second direction.

The plurality of second split mirrors may include a translucent mirror configured to reflect some of the light incident on the plurality of second split mirrors and transmit a remainder of the light.

The plurality of first split mirrors may be arranged to be inclined at a preset angle with respect to a plane formed by an axial line of a third direction which is toward which a gaze of a user is directed and the axial line of the second direction.

The plurality of first split mirrors may be respectively arranged at an upper side and a lower side with respect to a middle area of the display in the first direction, and a first split mirror of the plurality of first split mirrors arranged at the upper side and a first split mirror of the plurality of first split mirrors is arranged at the lower side may be inclined symmetrical to each other.

The display apparatus may further include a light guiding member configured to include an upper surface contacting the inclined surface and having an area corresponding to the inclined surface, and a lower surface configured to face the light from the display, and transmit light which is incident to the lower surface, wherein the lower surface may include a larger area than the upper surface.

The light guiding member may include a same material as the light guide plate, and the light guiding member and the light guide plate may be formed as a single body.

The light guide plate may be extended along the second direction so that light entering through the light incident surface can be guided in the second direction.

The display apparatus may further include: a first frame including a first end portion configured to be supported on at least one of a left head side and a right head side of a user and extends along a third direction which is toward which a gaze of the user is directed; and a second frame configured to be coupled with the first frame and the light guide plate, wherein the display is located in the second frame, wherein the second frame is extended and inclined at a preset angle with regard to the axial line of the second direction and an axial line of the third direction.

The first direction may include an up and down direction which is substantially perpendicular to the second direction.

The first direction may include a substantially vertical direction, and the second direction includes a substantially horizontal direction.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a perspective view showing an outer appearance of a display apparatus according to a first exemplary embodiment;

FIG. 2 is a block diagram of the display apparatus of FIG. 1, in accordance with an exemplary embodiment;

FIG. 3 is a view showing an example of an image transmission structure in the display apparatus of FIG. 1, in accordance with an exemplary embodiment;

FIG. 4 is a view showing an example of an image transmission structure in a display apparatus according to a second exemplary embodiment;

FIG. 5 is a perspective view partially showing an outer appearance of the display apparatus of FIG. 4, in accordance with an exemplary embodiment;

FIG. 6 is a view partially showing a light guide plate according to a third exemplary embodiment;

FIG. 7 is a top view of an image transmission structure in a display apparatus according to a fourth exemplary embodiment;

FIG. 8 is a side view of the image transmission structure in the display apparatus of FIG. 7, in accordance with an exemplary embodiment; and

FIG. 9 is a view partially showing a light guide plate according to a fifth exemplary embodiment.

### DETAILED DESCRIPTION OF EXEMPLARY EMBODIMENTS

Below, exemplary embodiments will be described in detail with reference to accompanying drawings. In the following exemplary embodiments, only elements directly related to the exemplary embodiment will be described, and descriptions about the other elements will be omitted. However, it will be appreciated that the elements, the descriptions of which are omitted, are not unnecessary to realize the apparatus or system according to the exemplary embodiments.

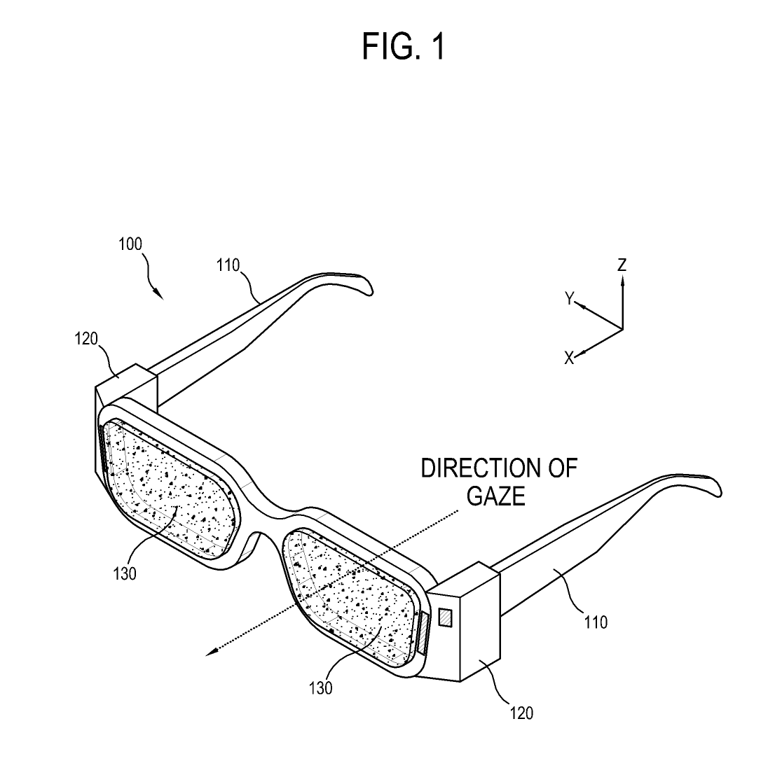

FIG. 1 is a perspective view showing an outer appearance of a display apparatus 100 according to a first exemplary embodiment.

Referring to FIG. 1, the display apparatus 100 according to this exemplary embodiment is a head-mount type display apparatus that can be mounted on a user's head. As shown therein, the display apparatus 100 may have a structure similar to general eyeglasses which cover the left and right eye of a user, or may be configured to cover only one of the left or right eye of the user. The following exemplary embodiment will describe the structure of the display apparatus 100 with respect to only one of a user's left or right eye. However, the structure of this exemplary embodiment can be applied to the structure which is used for both the right and left eye since the structure for a user's left eye and the structure for the right eye are symmetrical to each other. Therefore, repetitive descriptions will be avoided as necessary.

The display apparatus 100 includes a first frame 110 which is placed or hung on a user's ear, a second frame 120 which is coupled to an end portion of the first frame 110 and accommodating a display panel (not shown) for displaying an image and an optical system (not shown) therein, and glass 130 supported on the second frame 120 to cover a user's eye and transmit an image to the eye.

In addition, the display apparatus 100 may further include a shutter (not shown) which is installed in front of the glass 130 and performs a shuttering operation if the display apparatus 100 is to display a three-dimensional (3D) image which corresponds to an image displayed on an external display apparatus (not shown).

In the accompanying drawings, the directions are as follows: a direction of a user's gaze will be defined as an X direction, a direction transverse to the X direction will be defined as a Y direction, and a direction perpendicular to the axial lines of the X and Y directions will be defined as a Z direction. Further, a direction which is opposite to the X direction will be defined as a −X direction.

The first frame 110 is substantially extended along the X direction, and one end portion of the first frame 110 is hung on a user's ear. The first frame 110 may be provided to accommodate some elements of the display apparatus 100, or may only serve as a mechanism for placing the display apparatus 100 on a user's head and does not accommodate elements of the display apparatus 100. The first frame 110 is coupled to the second frame 120 at the other end portion of the first frame 110, and a hinge structure (not shown) may be provided between the first frame 110 and the second frame 120 in accordance with a design of the display apparatus 100.

The second frame 120 is substantially extended along the X direction, and has a first area which is coupled with the first frame 110 and a second area which is coupled with the glass 130. The second frame 120 forms an accommodating area for accommodating most of the elements of the display apparatus 100. In the second frame 120, an area which is coupled with the glass 130 has an optical path through which an image which is displayed on a display panel (not shown) which is accommodated in the second frame 120 is transmitted to the glass 130.

The glass 130 is substantially extended along the Y direction to traverse a user's gaze. The glass 130 guides light projected from the second frame 120 to a user's eye so that a user can recognize an image. To this end, the glass 130 transmits light from the second frame 120 to a user's eye, and adjusts the direction of the transmitted light to toward a user's eye.

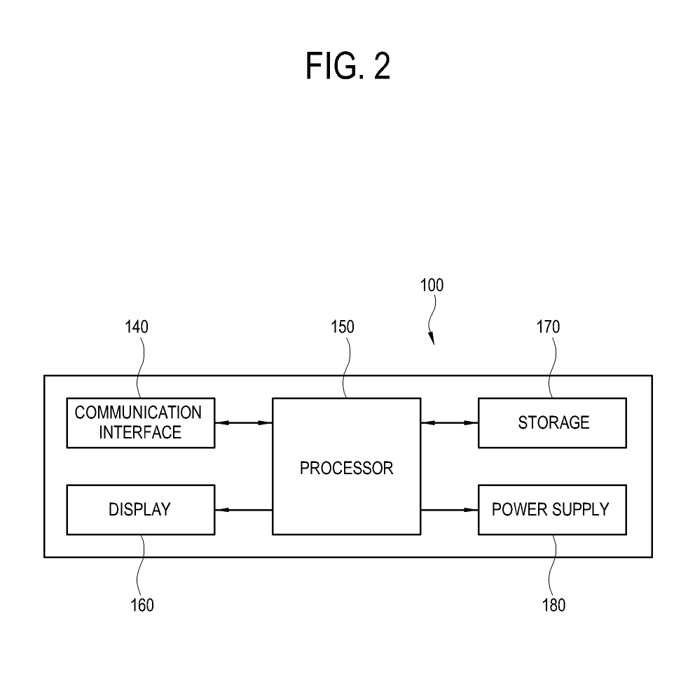

Below, elements of the display apparatus 100 will be described with reference to FIG. 2.

FIG. 2 is a block diagram of the display apparatus 100, in accordance with an exemplary embodiment.

Most elements of the display apparatus 100 shown in FIG. 2 are accommodated in the second frame 120, but the shape or method of accommodating these elements can vary and is not limited to this exemplary embodiment.

Further, the following elements of the display apparatus 100 are just given as an example, and therefore another element not shown or not described herein may be necessary for the display apparatus 100. In other words, the elements of the display apparatus 100 are not limited to the following elements.

As shown in FIG. 2, the display apparatus 100 includes a communication interface 140 which communicates externally to transmit and receive data or signals, a processor 150 to process data received in the communication interface 140 in accordance with preset processes, a display 160 to display an image based on image data if data processed by the processor 150 is the image data, a storage 170 to store the data or information, and a power supply 180 to supply power for operating the display apparatus 100.

The communication interface 140 transmits and receives data so that the display apparatus 100 can interactively communicate with various external devices (not shown). The communication interface 140 may connect with one or more external devices (not shown) through a wire or wirelessly by a broadband or a local area network or a local connection method in accordance with preset communication protocols.

The communication interface 140 may be achieved by connection ports for respective devices or an assembly of connection modules, and therefore a protocol for the connection or a connection target is not limited to one kind or type. That is, the communication interface 140 may simultaneously connect with the plurality of external devices in accordance with a plurality of protocols. However, for purposes of convenience, it is advantageous to employ a wireless communication module as the communication interface 140 since the display apparatus 100 is a head-mount type.

The processor 120 performs various processes with regard to data or signals received in the communication interface 140. If the communication interface 140 receives the image data, the processor 150 performs an image processing process with regard to the image data, and the processed image data is output to the display 160 so that an image based on the image data can be displayed on the display 160. If the signal received in the communication interface 140 is a broadcasting signal, the processor 150 extracts an image, sound and supplementary data from a broadcasting signal tuned to a certain channel, and controls the image to have a preset resolution and displays the image on the display 160.

There is no limit to the kind of image processing processes performed by the processor 150. For example, the image processing process may include decoding corresponding to an image format of image data, de-interlacing for converting an interlaced type of image data into a progressive type, scaling for adjusting image data to have a preset resolution, noise reduction for enhancing image quality, detail enhancement, frame refresh rate conversion, etc.

The processor 150 may be achieved by a system-on-chip where various functions are integrated, or by an image processing board (not shown) on which individual chipsets for independently performing the respective processes are mounted on a printed circuit board.

The display 160 is achieved by a display panel that displays an image based on the image signal or the image data processed by the processor 150. In this exemplary embodiment, the display apparatus 100 has an image transmission structure for transmitting an image displayed on the display 160 to a user's eye. This structure will be described later.

The storage 170 stores a variety of data under the control of the processor 150. The storage 170 is achieved by a nonvolatile memory such as a flash memory, a hard disk drive, or the like to preserve data regardless of whether the system power is on or off. The storage 170 is accessed by the processor 150 to read, record, modify, delete and update the previously stored data.

The power supply 180 supplies direct current (DC) power for operating all of the elements of the display apparatus 100. The power supply 180 may be achieved by a primary battery or a secondary battery. In this exemplary embodiment, a secondary battery which is rechargeable with external power is used. The power supply 180 supplies power under control of the processor 150. For example, the processor 150 may control whether to output power to a certain element, a level of the output voltage, adjustment of output duty, etc.

Below, the image transmission structure for transmitting the image displayed on the display 160 to a user's eye will be described.

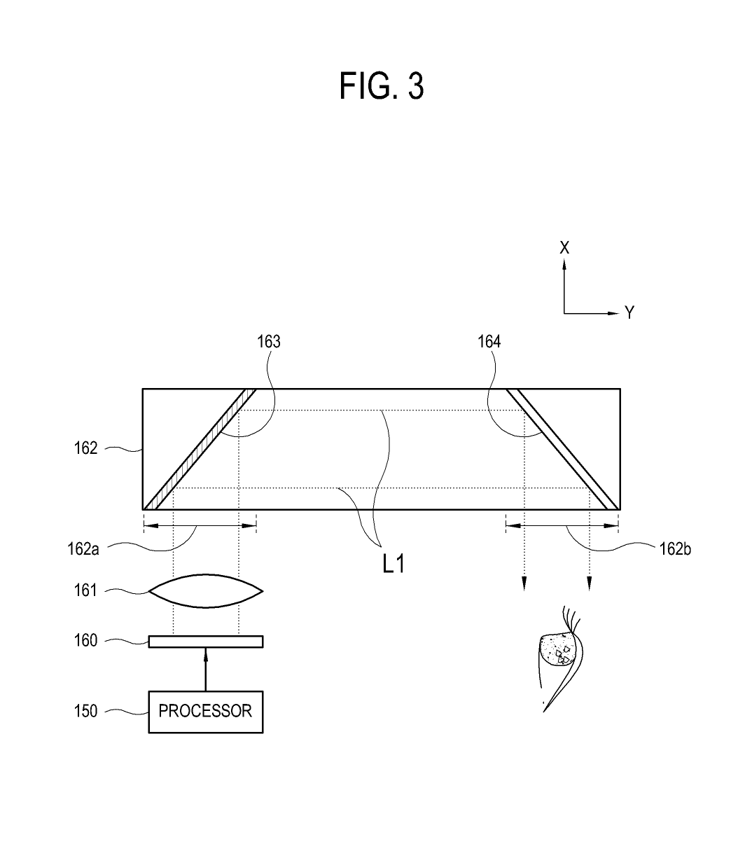

FIG. 3 is a view showing an example of an image transmission structure in the display apparatus 100, in which the structure of the display apparatus 100 which corresponds to a user's left eye is viewed from the top, in accordance with an exemplary embodiment.

As shown in FIG. 3, the image data processed by the processor 150 is displayed as an image on the display 160. The image displayed on the display 160 is transmitted to a user's eye through the image transmission structure accommodated in the second frame 120 and the glass 130.

The image transmission structure includes an optical lens system 161 for adjusting properties of light L1 exiting the display 160, a light guide plate 162 for guiding the transmission of the light L1 exiting the optical lens system 161, a reflection mirror 163 embedded in the light guide plate 162 and which totally reflects the light L1 incident to the light guide plate 162, and a translucent mirror 164 which reflects the light L1 transmitted through the light guide plate 162 toward a user's eye.

The optical lens system 161 is accommodated in the second frame 120, and adjusts the light L1 which exits the display 160 in the X direction. The optical lens system 161 includes one or more lenses or plates for adjusting various properties of the light L1 output from the display 160 so that an image can have a proper size and resolution when the corresponding image is displayed on the display 160.

The optical lens system 161 may be made up of a combination of various kinds of lenses such as an ocular lens, a condenser lens, etc. in accordance with the characteristics of the display apparatus 100, such as the properties of the display 160. However, these are merely examples and the exemplary embodiments can be implemented in various ways. In FIG. 3, the optical lens system 161 is achieved by one lens, but the exemplary embodiments are not limited thereto. Alternatively, the optical lens system 161 may have a structure where two or more lenses may be sequentially arranged in accordance with a desired design.

The light L1 which exits the optical lens system 161 enters a light incident surface 162a of the light guide plate 162 formed in a left area on a −X directional surface of the light guide plate 162.

The light guide plate 162 is accommodated in the glass 130 and extends along the Y direction. On the −X directional surface of the light guide plate 162, i.e. on a surface direction from the light guide plate 162 toward the optical lens system 161 and a user's eye, a light incident surface 162a and a light exit surface 162b are formed. The light guide plate 162 guides the light L1 so that the light L1 propagates inside the light guide plate 162 along the Y direction if the light L1 incident on the light incident surface 162a is totally reflected from the reflection mirror 163 in the Y direction.

The reflection mirror 163 is embedded in the light guide plate 162 in a straight line direction of the light incident surface 162a. The reflection mirror 163 totally reflects the light L1 incident on the light incident surface 162a, so that the light L1 can propagate within the light guide plate 162.

The translucent mirror 164 reflects the light L1 propagating within the light guide plate 162 in the −X direction, thereby guiding the light L1 toward a user's eye. A user recognizes the light L1 reflected from the translucent mirror 164 and thus views an image which is displayed on the display 160. As opposed to the reflection mirror 163, the translucent mirror 164 is provided to transmit some light, so that a user can also view an ambient environment through the translucent mirror 164.

With this configuration, the display apparatus 100 provides an image displayed on the display 160 which can be recognized by a user.

The foregoing optical system or image transmission structure for the head-mount type display apparatus 100 employs the light guide plate 162, thereby simplifying the image transmission structure and reducing the whole volume of the image transmission structure. To transmit an image displayed on the display 160 to a user's eye, many lenses are combined to make up the optical lens system 161. However, since the display apparatus 100 is hung on a user's nose and ears, the image transmission structure has to be manufactured to be as lightweight and as simple as possible. To this end, there is a need for designing the light guide plate 162 to be small and thin.

If the image transmission structure is created without the light guide plate 162, the image transmission structure can be complicated. In order to decrease the volume of the display apparatus 100, the light guide plate 162 is needed. However, in a structure which allows a user recognize a high definition and large-sized image, it may be not easy to decrease the thickness and size of the light guide plate 162 in the display apparatus 100.

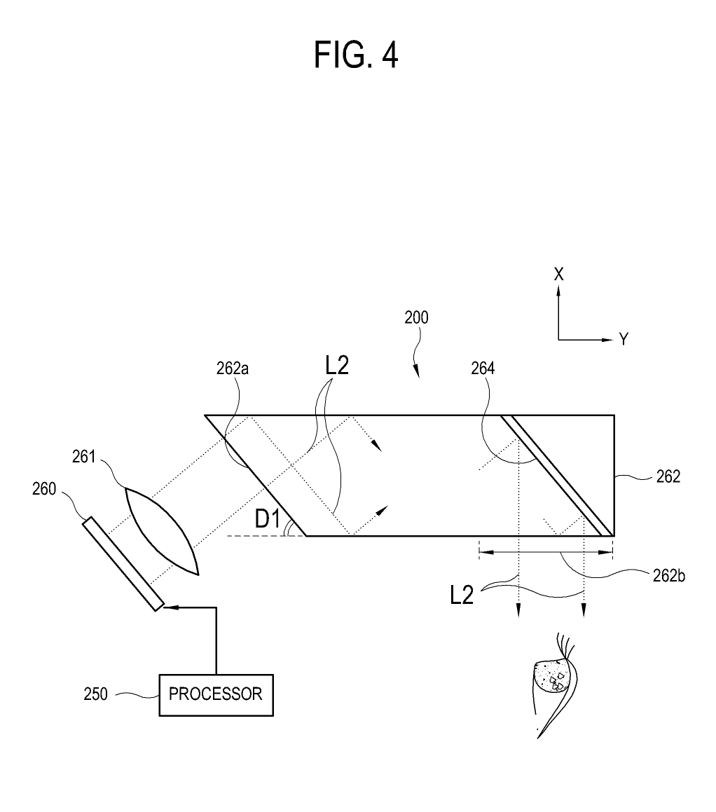

In this regard, a second exemplary embodiment will be described with reference to FIG. 4.

FIG. 4 is a view showing an example of an image transmission structure in a display apparatus 200 according to a second exemplary embodiment. The structure which is described in this exemplary embodiment may be applied to the display apparatus 100 according to the first exemplary embodiment.

As shown in FIG. 4, image data processed by a processor 250 is displayed as an image on a display 260. The image displayed on the display 260 is transmitted to a user's eye through the image transmission structure.

The image transmission structure includes an optical lens system 261 for adjusting properties of light L2 exiting from the display 260, a light guide plate 262 for guiding transmission of the light L2 exiting from the optical lens system 261, and a translucent mirror 264 reflecting the light L2 transmitted through the light guide plate 262 toward a user's eye. The functions of these elements are the same as those of like elements of the first exemplary embodiment, and thus repetitive descriptions will be avoided as necessary.

In the foregoing first exemplary embodiment, the light incident surface 162a of the light guide plate 162 (see FIG. 3) is formed in parallel with the Y direction, so that the light incident to the light incident surface 162a along the X direction can be reflected from the reflection mirror 163 in the Y direction.

In contrast, the second exemplary embodiment does not include an element which corresponds to the reflection mirror 163 of the first exemplary embodiment. Further, a light incident surface 262a of the light guide plate 262 according to the second exemplary embodiment is achieved by an inclined surface formed at a preset angle of D1 with respect to the lengthwise direction of the light guide plate 262, i.e. the axial line of the Y direction. Further, as opposed to the first exemplary embodiment, the display 260 and the optical lens system 261 according to the second exemplary embodiment are arranged at a predetermined angle to the axial line of the X direction. Therefore, the light L2 exiting from the optical lens system 261 can transversely enter the light incident surface 262a.

The light L2 incident on the light incident surface 262a formed at the angle D1 with respect to the axial line of the Y direction reaches the translucent mirror 264 through reflection and propagation inside the light guide plate 262. The translucent mirror 264 reflects the light L2 toward a user's eye so that the user can recognize the image from the display 260.

The angle D1 may vary depending on the design of the display apparatus 200. For example, if the angle D1 is 0 degrees, the first exemplary embodiment can be used which includes the reflection mirror 163 (see FIG. 3). If the angle D1 is approximately 0 degrees but the reflection mirror 163 (see FIG. 3) is not provided, the amount of light L2 which exits toward the user's eye may be more than the amount of light L2 traveling in the Y direction along the light guide plate 262. On the other hand, if the angle D1 is equal to or approximately 90 degrees, the display 260 and the optical lens system 261 have to be arranged in parallel with the light guide plate 262 and thus it is not easy to design the display apparatus 200 in light of a user wearing the structure. Taking this into account, the angle D1 may have various values.

According to this second exemplary embodiment, the light incident surface 262a of the light guide plate 262 is achieved by an inclined surface formed at a preset angle D1 with respect to a longitudinal axial line of the light guide plate 262, and it is therefore possible to exclude the reflection mirror 163 and decrease the length of the light guide plate 262 as compared with that of the first exemplary embodiment.

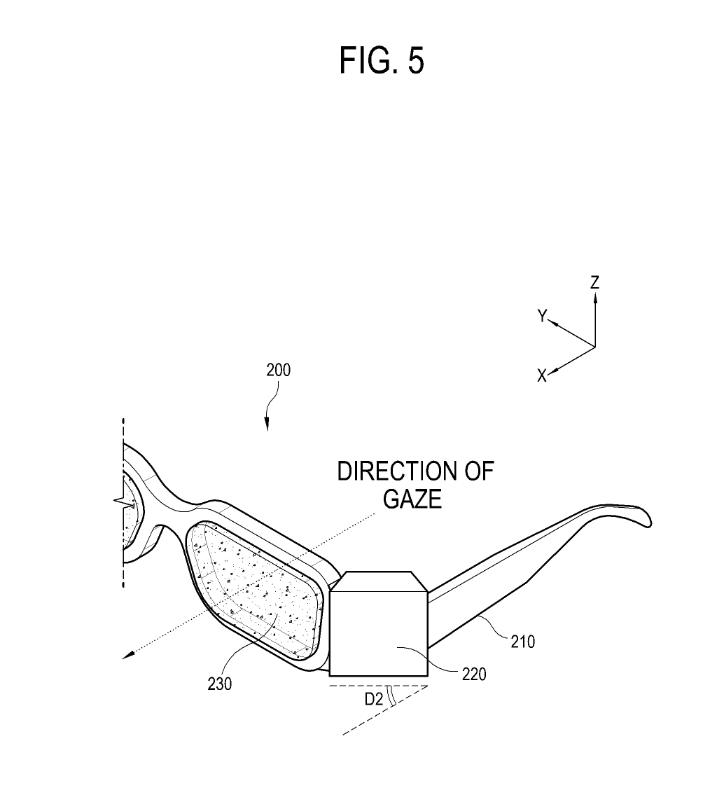

FIG. 5 is a perspective view partially showing an outer appearance of the display apparatus 200 according to the second exemplary embodiment.

As shown in FIG. 5, the display apparatus 200 includes a first frame 210 which is hung or placed on a user's ear, a second frame 220 which is coupled to an end portion of the first frame 210, and glass 230 which is supported on the second frame 220 to cover a user's eye. The second frame 220 accommodates the display 260 and the optical lens system 261 of FIG. 4, and the glass 230 includes the light guide plate 262.

The first frame 210 is substantially extended along the X direction, and the glass 230 is substantially extended along the Y direction. In accordance with an arrangement of the display 260 and the optical lens system 261 and the structure of the light guide plate 262, the second frame 220 is extended so as to be inclined at a predetermined angle D2 with respect to the extended direction of the first frame 210, i.e. the axial line of the X direction.

The second frame 220 according to the second exemplary embodiment is extended so as to be inclined in the Y direction, whereas the second frame 120 (see FIG. 1) according to the first exemplary embodiment is extended in parallel with the axial line of the X direction. With the image transmission structure and the second frame 220 achieved as above, the length of the light guide plate 262 can be shorter than that of the first exemplary embodiment.

As the size and weight of the light guide plate 262 are decreased, the production costs for the display apparatus 200 can be decreased and the display apparatus is more comfortable for a user to wear.

In the foregoing exemplary embodiments, only one translucent mirror 164 or translucent mirror 264 is installed to reflect the light which propagates within the light guide plate 162 or light guide plate 262, toward a user's eye. However, it may be more efficient to use more than one or many translucent mirrors for horizontally splitting and reflecting the light, rather than to use one translucent mirror 164 or translucent mirror 264 for reflecting the light. As a result, the thickness of the light guide plate 162 or light guide plate 262 can be reduced using many translucent mirrors.

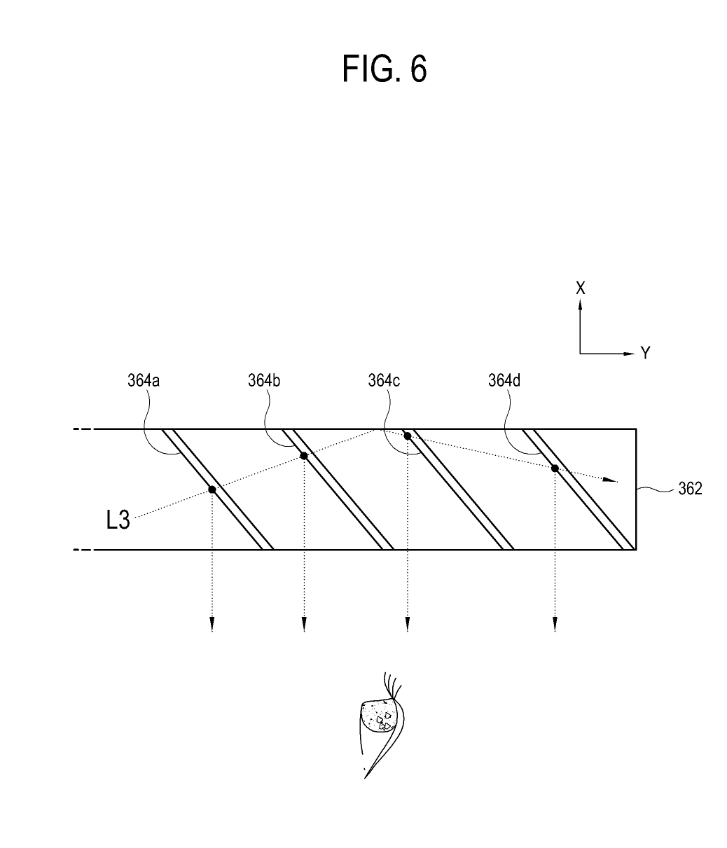

Below, a third exemplary embodiment will be described with reference to FIG. 6.

FIG. 6 is a view partially showing a light guide plate 362 according to a third exemplary embodiment. The light guide plate 362 and translucent mirrors 364a, 364b, 364c, 364d may be applied to the display apparatus 200 according to the second exemplary embodiment, and may also be applied to the display apparatus 100 according to the first exemplary embodiment.

As shown in FIG. 6, the light guide plate 362 transmits the light L3 propagating therein in the Y direction. The light L3 is reflected and reflected again within the light guide plate 362 and travels in the Y direction, thereby reaching the plurality of translucent mirrors 364a, 364b, 364c and 364d arranged in sequence along the Y direction.

The plurality of translucent mirrors 364a, 364b, 364c and 364d are sequentially arranged inside the light guide plate 362 along a traveling direction of the light L3 propagating in the light guide plate 362. A first translucent mirror 364a transmits some of the light L3 and reflects the remainder of the light L3 toward a user's eye. A second translucent mirror 364b transmits some of the light L3 transmitted through the first translucent mirror 364a and reflects the remainder of the light L3 toward a user's eye. Likewise, a third translucent mirror 364c and a fourth translucent mirror 364d also perform the same functions.

Since the structure of the translucent mirrors 364a, 364b, 364c, 364d horizontally splits and reflects the light L3, it is possible to efficiently reflect light and reduce the thickness of the light guide plate 362.

In the foregoing exemplary embodiments, the light exiting from the optical lens system 161 or optical lens system 261 directly enters the light guide plate 162 or light guide plate 262, respectively. Alternatively, an element may be added to vertically split the light exiting from the optical lens system 161 or optical lens system 261 and transmits the vertically split light to the light guide plate 162 or light guide plate 262, respectively. If this element is combined to the foregoing third exemplary embodiment, light is vertically and horizontally split and propagated so that a user can more clearly recognize an image.

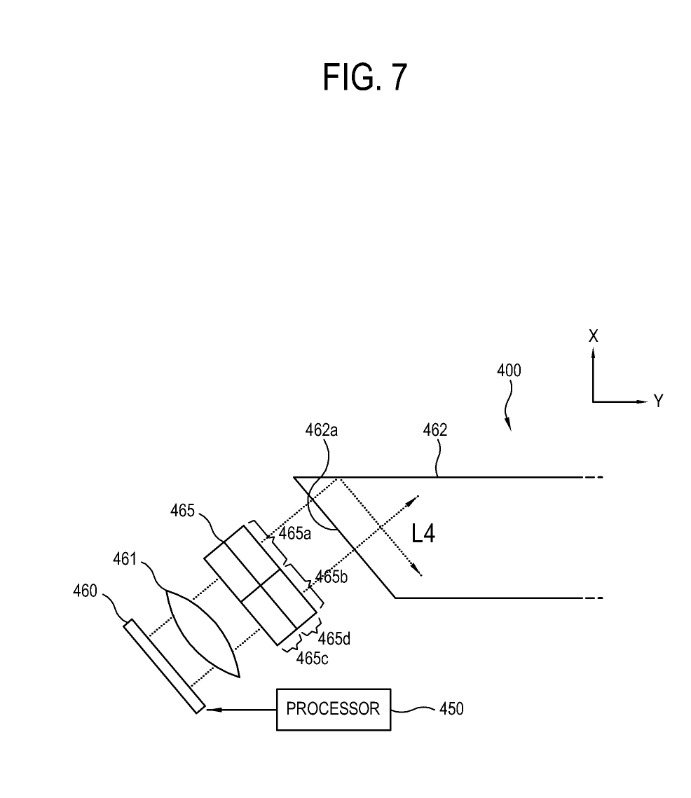

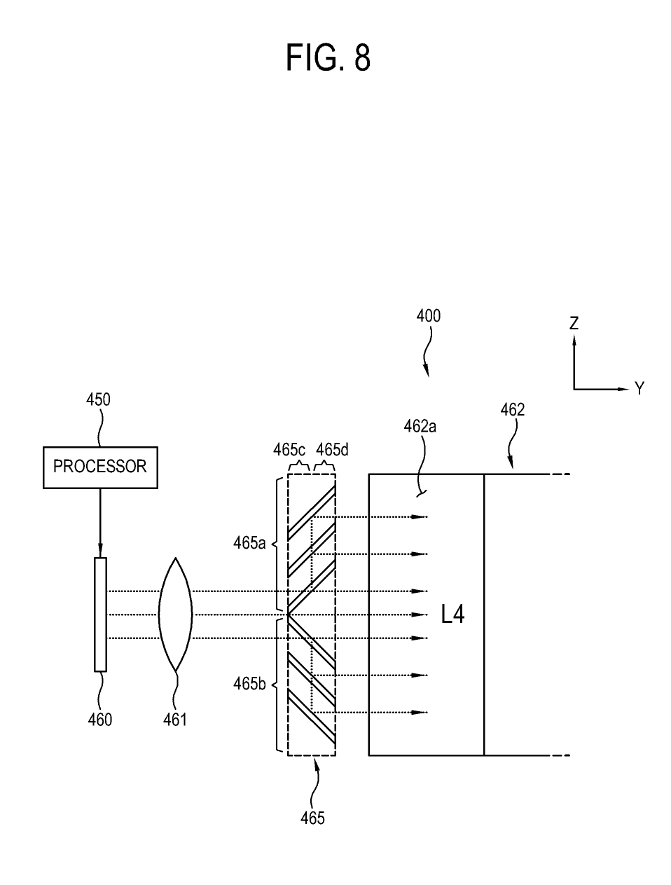

Below, a fourth exemplary embodiment will be described with reference to FIG. 7 and FIG. 8.

FIG. 7 is a top view of an image transmission structure in a display apparatus 400 according to a fourth exemplary embodiment, and FIG. 8 is a side view of the image transmission structure in the display apparatus 400 of FIG. 7. That is, FIGS. 7 and 8 are top and side views of the same image transmission structure, respectively. Further, the structure described in this exemplary embodiment may be applied to the exemplary embodiments described above.

As shown in FIGS. 7 and 8, image data processed by the processor 450 is displayed as an image on a display 460, and the image displayed on the display 460 is transmitted to a user's eye through the image transmission structure.

In this exemplary embodiment, the image transmission structure includes an optical lens system 461 for adjusting properties of light L4 exiting from the display 460, a plurality of vertical split mirrors 465 vertically splitting the light L4 exiting from the optical lens system 461, and a light guide plate 462 for guiding transmission of the light L4 split by the vertical split mirrors 465. Although it is not shown, the image transmission structure further includes a translucent mirror (not shown) for reflecting the light L4 transmitted through the light guide plate 462 toward a user's eye. Thus, this exemplary embodiment is achieved by adding the vertical split mirror 465 to the structure according to, for example, the second or third exemplary embodiment. Alternatively, the vertical split mirror 465 may be added to the structure according to the first exemplary embodiment.

The plurality of vertical split mirrors 465 are arranged in sequence along a vertical direction, i.e. along the axial line of the Z direction. Each vertical split mirror 465 is arranged to have a reflective surface which is inclined at a predetermined angle to an X-Y plane. Referring to FIG. 8, the vertical split mirror 465 is divided into an upper vertical split mirror 465a and a lower vertical split mirror 465b with respect to the middle of the Z direction of the display 460 or the optical lens system 461, in which the upper vertical split mirror 465a and the lower vertical split mirror 465b are inclined to be symmetrical to each other.

With this configuration, when the light L4 which exits the optical lens system 461 reaches the first vertical split mirror 465, some of the light L4 which is transmitted through the first vertical split mirror 465 enter a light incident surface 462a of the light guide plate 462, and the remainder of the light L4 which is reflected from the first vertical split mirror 465c reaches the second vertical split mirror 465d adjacent to an upper or lower side of the first vertical split mirror 465. The light L4 that has reached the second vertical split mirror 465 is transmitted and reflected by the same principle as that of the first vertical split mirror 465.

Thus, the light L4 exiting from the optical lens system 461 is vertically split by the plurality of vertical split mirrors 465 and enters the light guide plate 462. In this exemplary embodiment, the vertical split mirror 465 functions to vertically split the light L4, and thus has a different function from the reflection mirror 163 according to the first exemplary embodiment. However, the vertical split mirror 465 may reflect the light L4 to additionally adjust the traveling direction of the light L4 in accordance with the design of the display apparatus 400.

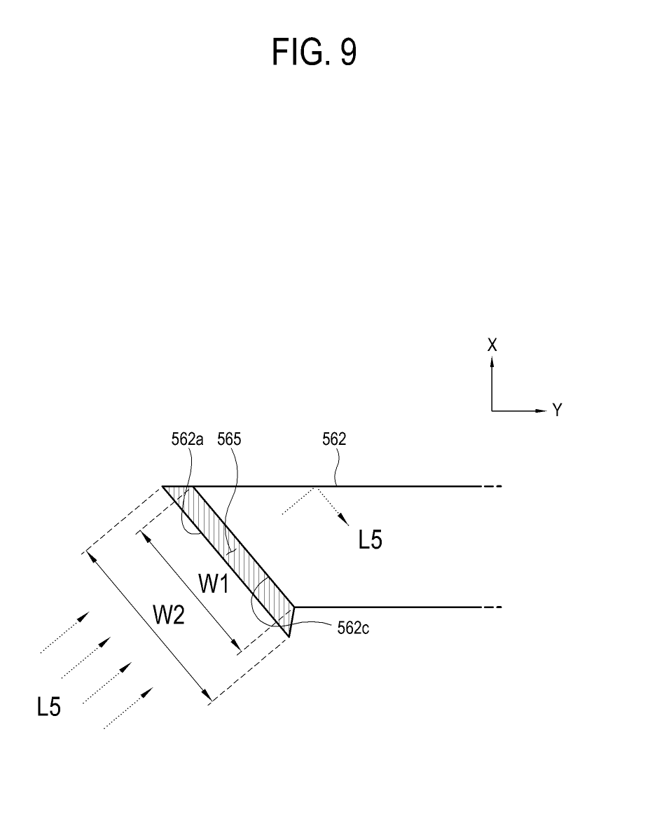

According to the second exemplary embodiment in connection with FIG. 4, the light incident surface 262a of the light guide plate 262 forms an inclined surface formed at an angle D1 to the axial line of the extended direction of the light guide plate 262. However, the amount of light incident to the light incident surface 262a may be increased by enlarging the area of the light incident surface 262a. Below, such a fifth exemplary embodiment will be described with reference to FIG. 9.

FIG. 9 is a view partially showing a light guide plate 565 according to a fifth exemplary embodiment. The light guide plate 562 according to this exemplary embodiment may be applied to the exemplary embodiments discussed above.

As shown in FIG. 9, the light guide plate 562 includes an inclined surface 562c inclined at a preset angle with respect to the axial line of the Y direction. In the second exemplary embodiment, this inclined surface 562c forms the light incident surface 262a (see FIG. 4).

However, the light guide plate 562 in this exemplary embodiment further includes a light guiding member 565 having a trapezoidal or wedge-shaped cross-section. The light guiding member 565 is made of the same material as the light guide plate 562, and may be formed integrally with the light guide plate 562.

The light guiding member 565 contacts the inclined surface 562c and includes an upper surface having an area corresponding to the inclined surface 562c, and a lower surface facing the incident light L5. Here, the area of the lower surface is larger than that of the upper surface.

In other words, referring to the cross-section of the light guiding member 565 taken along the X-Y plane, a lower edge facing the incident direction of the light L5 is longer than an upper edge contacting the inclined surface 562c, and this lower edge forms the light incident surface 562a of the light guide plate 562. Accordingly, the light guide plate 562 according to the fifth exemplary embodiment can receive more light L5 than that of the second exemplary embodiment since the width W2 of the light incident surface 562a according to the fifth exemplary embodiment is wider than the width W1 of the light incident surface 562c according to the second exemplary embodiment.

Although a few exemplary embodiments have been shown and described, it will be appreciated by those skilled in the art that changes may be made in these exemplary embodiments without departing from the principles and spirit of the inventive concept, the scope of which is defined in the appended claims and their equivalents.

What is claimed is:

1. A head-mount type display apparatus comprising:
a display configured to display an image;
a light guide plate configured to transmit light which enters the light guide plate through a light incident surface formed at a first side of the light guide plate;
a plurality of first split mirrors configured to be arranged in sequence along a first direction, and reflect light so that light from the display can be split in the first direction and enter the light incident surface; and
a plurality of second split mirrors configured to be arranged in sequence along a second direction which is preset differently from the first direction, split light transmitted through the light guide plate in the second direction, and reflect the split light so that the image displayed on the display can be recognized,
wherein the light incident surface of the light guide plate comprises an inclined surface formed at a preset angle with respect to an axial line of the second direction.

2. The display apparatus according to claim 1, wherein the plurality of second split mirrors comprises a translucent mirror configured to reflect some of the light incident on the plurality of second split mirrors and transmit a remainder of the light.

3. The display apparatus according to claim 1, wherein the plurality of first split mirrors is arranged to be inclined at a preset angle with respect to a plane formed by an axial line of a third direction which is toward which a gaze of a user is directed and the axial line of the second direction.

4. The display apparatus according to claim 3, wherein the plurality of first split mirrors are respectively arranged at an upper side and a lower side with respect to a middle area of the display in the first direction, and a first split mirror of the plurality of first split mirrors arranged at the upper side and a first split mirror of the plurality of first split mirrors is arranged at the lower side are inclined symmetrical to each other.

5. The display apparatus according to claim 1, further comprising a light guiding member comprising an upper surface configured to contact the inclined surface and comprising an area corresponding to the inclined surface, and a lower surface configured to face the light from the display, and transmit light which is incident to the lower surface,
wherein the lower surface comprises a larger area than the upper surface.

6. The display apparatus according to claim 5, wherein the light guiding member comprises a same material as the light guide plate, and the light guiding member and the light guide plate are formed as a single body.

7. The display apparatus according to claim 1, wherein the light guide plate is extended along the second direction so that light entering through the light incident surface can be guided in the second direction.

8. The display apparatus according to claim 7, further comprising:
a first frame comprising a first end portion configured to be supported on at least one of a left head side and a right head sides of a user and extends along a third direction which is toward which a gaze of the user is directed; and
a second frame configured to be coupled with the first frame and the light guide plate, wherein the display is located in the second frame,
wherein the second frame is extended and inclined at a preset angle with regard to the axial line of the second direction and an axial line of the third direction.

9. The display apparatus according to claim 1, wherein the first direction comprises an up and down direction which is substantially perpendicular to the second direction.

10. The display apparatus according to claim 1, wherein the first direction comprises a substantially vertical direction, and the second direction comprises a substantially horizontal direction.

11. The head-mount type display apparatus according to claim 1, wherein the light which is split in the second direction is reflected toward an eye of a user.

12. The head-mount type display apparatus according to claim 1, wherein the light guide plate is located in a glass portion of the head-mount type display apparatus.

13. A head-mount type display apparatus comprising:
a display configured to display an image;
a light guide plate configured to transmit light which enters the light guide plate through a light incident surface formed at a first side of the light guide plate;
a first split mirror configured to be arranged along a first direction, and reflect light so that light from the display can be split in the first direction and enter the light incident surface; and
a second split mirror configured to be arranged in a second direction which is different from the first direction, split light transmitted through the light guide plate in the second direction, and reflect the split light so that the image displayed on the display can be recognized.

14. A method of displaying an image on a head-mount type display apparatus, the method comprising:
displaying an image on a display;
transmitting light which enters a light guide plate through a light incident surface formed at a first side of the light guide plate;
reflecting light, by a first split mirror arranged along a first direction, so that light from the display can be split in the first direction and enter the light incident surface; and
splitting light, by a second split mirror arranged in a second direction which is different from the first direction, which is transmitted through the light guide plate in the second direction, and
reflecting the split light so that the image which is displayed can be recognized.
